(19) United States
(12) Patent Application Publication
(10) Pub. No.: US 2024/0054844 A1
(43) Pub. Date: Feb. 15, 2024

(54) MONEY HANDLING APPARATUS AND METHOD AND PROGRAM FOR PRODUCING MONEY HANDLING APPARATUS

(71) Applicant: GLORY LTD., Hyogo (JP)

(72) Inventors: Hidetomo YANAGIUCHI, Hyogo (JP); Tooru MUKUNO, Hyogo (JP); Tetsuya YAMAUCHI, Hyogo (JP)

(21) Appl. No.: 18/446,543

(22) Filed: Aug. 9, 2023

(30) Foreign Application Priority Data
Aug. 12, 2022 (JP) 2022-128847

(51) Int. Cl. G07D 11/18

(52) U.S. Cl. CPC G07D 11/18; G07D 2211/00

(57) ABSTRACT

A money handling apparatus includes an upper module including an upper transport section for transporting money and a lower module including a lower transport section for transporting the money. In the apparatus, a middle transport module including a middle transport section for transporting the money between a first end to be connected to an end of the upper transport section and a second end to be connected to an end of the lower transport section is selectively attached to the lower module to place the end of the upper transport section and the end of the lower transport section in one of a plurality of different positional relationships between the ends to enable the transporting of the money between the upper transport section and the lower transport section.

### CROSS REFERENCE TO RELATED APPLICATIONS

This application is entitled and claims the benefit of Japanese Patent Application No. 2022-128847, filed on Aug. 12, 2022, the disclosure of which including the specification, drawings and abstract is incorporated herein by reference in its entirety.

### TECHNICAL FIELD

The present disclosure relates to a money handling apparatus configured to store money, namely at least one of banknotes, coins, or sheets, and a method and a program for producing the money handling apparatus.

### BACKGROUND ART

Money handling apparatuses that accept money and perform various processes on the money are widely provided. A money handling apparatus generally is composed of a combination of a plurality of types of units such as a deposit unit that accepts deposits of money, a storage unit that stores deposited money, a withdrawal unit that dispenses money, and a transport unit that transports money between units.

Units constituting the money handling apparatus have various shapes and sizes so as to be compatible with various uses. When designing a money handling apparatus by combining a plurality of types of units, it is necessary to adjust the layout of the units.

In particular, the transport unit is required to connect the money entrances and exits of the unit so that money can be transported between, for example, the deposit unit, the withdrawal unit, and the storage unit.

### SUMMARY

A money handling apparatus according to one aspect of the present disclosure comprises an upper module comprising an upper transport section for transporting money; and a lower module comprising a lower transport section for transporting the money, wherein
a middle transport module comprising a middle transport section for transporting the money between a first end to be connected to an end of the upper transport section and a second end to be connected to an end of the lower transport section is selectively attached to the lower module to place the end of the upper transport section and the end of the lower transport section in one of a plurality of different positional relationships between the ends of the upper and lower transport sections to enable transporting of the money between the upper transport section and the lower transport section.

### BRIEF DESCRIPTION OF DRAWINGS

FIG. 1 illustrates an exemplary internal structure of a money handling apparatus;

FIG. 2 illustrates an exemplary internal structure of a money handling apparatus to which a middle transport module is added;

FIG. 3 illustrates how a middle frame is attached to the lower frame;

FIG. 4A is a diagram for explaining a specific example of the external shape of the money handling apparatus;

FIG. 4B is a diagram for explaining a specific example of the external shape of the money handling apparatus;

FIG. 4C is a diagram for explaining a specific example of the external shape of the money handling apparatus;

FIG. 4D is a diagram for explaining a specific example of the external shape of the money handling apparatus;

FIG. 5A is a diagram exemplifying the internal structure of one of the money handling apparatuses enabling various external shapes;

FIG. 5B is a diagram exemplifying the internal structure of one of the money handling apparatuses enabling various external shapes;

FIG. 5C is a diagram exemplifying the internal structure of one of the money handling apparatuses enabling various external shapes;

FIG. 5D is a diagram exemplifying the internal structure of one of the money handling apparatuses enabling various external shapes;

FIG. 6 is a perspective view illustrating an exemplary middle transport module;

FIG. 7 is a diagram illustrating an exemplary configuration of a production control apparatus that controls production of a money handling apparatus; and

FIG. 8 is a flow chart for explaining a method for producing a money handling apparatus by the production control apparatus.

### DESCRIPTION OF EMBODIMENTS

An object of the present disclosure is to provide a money handling apparatus that is easily compatible with various layouts of a plurality of units and a method and a program for producing the money handling apparatus.

According to the money handling apparatus according to one aspect of the present disclosure, the lower module further comprises a lower frame to which the lower transport section is attached; and the middle transport module is attached and fixed to the lower frame. With such a configuration, the middle transport module can be removed from the lower module, and only the middle transport module can be taken out from the lower housing.

According to the money handling apparatus according to one aspect of the present disclosure, the lower module further comprises a movement mechanism for moving the lower frame with the lower transport section and the middle transport module attached thereto.

The money handling apparatus according to one aspect of the present disclosure further comprises a lower housing for housing the lower frame inside, the lower frame being with the lower transport section and the middle transport module attached thereto.

According to the money handling apparatus according to one aspect of the present disclosure, the middle transport module is attached to the lower frame from above.

According to the money handling apparatus according to one aspect of the present disclosure, the middle transport module comprises a middle frame to which the middle transport section is attached; and the middle transport module is fixed to the lower module by attaching the middle frame to the lower frame.

According to the money handling apparatus according to one aspect of the present disclosure, the middle transport module further comprises a motor for operating the middle transport section.

According to the money handling apparatus according to one aspect of the present disclosure, the middle transport module further comprises a detection section for detecting the money transported by the middle transport section.

According to the money handling apparatus according to one aspect of the present disclosure, the middle transport module further comprises a manual movement mechanism for manually moving the money in the middle transport section.

According to the money handling apparatus according to one aspect of the present disclosure, the middle frame comprises a protrusion, and is positioned by engaging the protrusion with a slit of the lower frame.

According to the money handling apparatus according to one aspect of the present disclosure, among a plurality of the middle transport modules having different positional relationships between the first end and the second end, a middle transport module having a configuration such that positions of the end of the upper transport section and the first end match each other and positions of the end of the lower transport section and the second end match each other is selectively attached to place the end of the upper transport section and the end of the lower transport section in one of the plurality of different positional relationships between the ends to enable the transporting of the money between the upper transport section and the lower transport section.

According to the money handling apparatus according to one aspect of the present disclosure, the middle transport module is exposed when the lower frame is pulled out by the movement mechanism.

According to the money handling apparatus according to one aspect of the present disclosure, when the lower housing is not a safe, the middle transport module is not attached, and a front surface of the upper module and a front surface of the lower module are aligned with each other; and when the lower housing is a safe, the middle transport module is attached, and the front surface of the upper module and a front surface of the safe housing the lower module are aligned with each other.

A method according to one aspect of the present disclosure for producing a money handling apparatus that comprises an upper module comprising an upper transport section for transporting money and a lower module comprising a lower transport section for transporting the money, the method comprising: acquiring, by a computer, information about a position of an end of the upper transport section and a position of an end of the lower transport section; selecting, by the computer, among a plurality of middle transport modules respectively comprising middle transport sections that have different positional relationships between a first end and a second end of each middle transport section, a middle transport module having a configuration such that the position of the end of the upper transport section and a position of the first end match each other, and the position of the end of the lower transport section and a position of the second end match each other; and outputting, by the computer, information about the middle transport module selected.

A program according to one aspect of the present disclosure for producing a money handling apparatus that comprises an upper module comprising an upper transport section for transporting money and a lower module comprising a lower transport section for transporting the money, the program causing a computer to execute a procedure comprising: acquiring information about a position of an end of the upper transport section and a position of an end of the lower transport section; selecting, among a plurality of middle transport modules respectively comprising middle transport sections that have different positional relationships between a first end and a second end of each middle transport section, a middle transport module having a configuration such that the position of the end of the upper transport section and a position of the first end match each other, and the position of the end of the lower transport section and a position of the second end match each other; and outputting information about the middle transport module selected.

The present disclosure is easily compatible with various layouts of a plurality of units.

Hereinafter, each embodiment of the present disclosure will be described in detail with reference to the drawings. However, detailed descriptions of already well-known matters and redundant descriptions of substantially the same configurations may be omitted.

In addition, in the embodiments, the same reference numerals are given to the common configurations, and redundant description may be omitted.

Description of Configuration

In the following, money handling apparatus 1 according to an embodiment of the present disclosure will be described in detail.

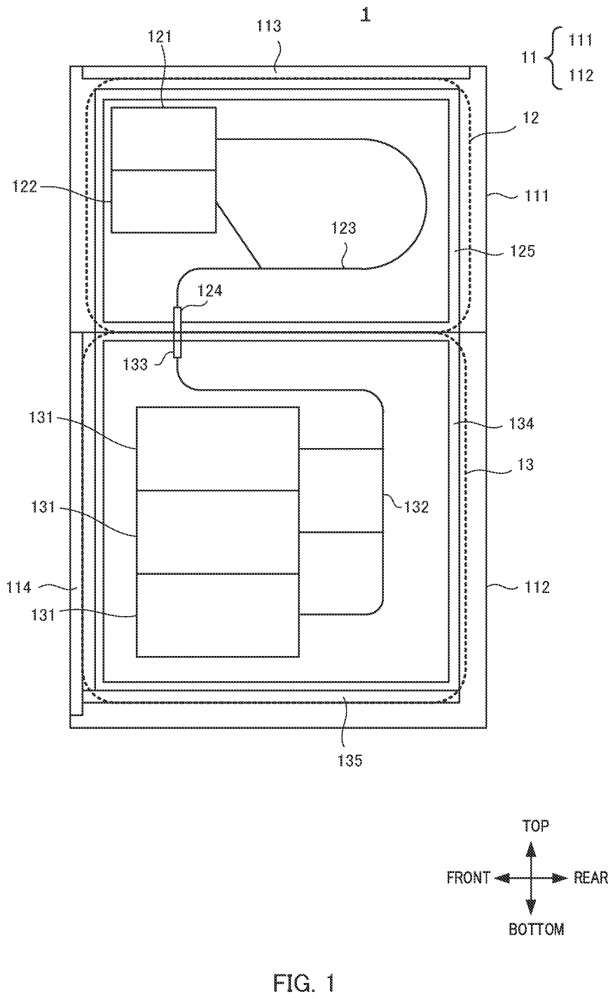

FIG. 1 illustrates an exemplary internal structure of a money handling apparatus 1. As illustrated in FIG. 1, the money handling apparatus 1 comprises a housing 11, an upper module 12, and a lower module 13. In the example illustrated in FIG. 1, the front of the money handling apparatus 1 is on the left side, and the rear of the money handling apparatus 1 is on the right side.

The housing 11 houses an upper module 12 and a lower module 13. The housing 11 comprises an upper housing 111 configured to house the upper module 12 and a lower housing 112 configured to house the lower module 13. In the example illustrated in FIG. 1, the upper housing 111 and the lower housing 112 are each a metal case composed of, for example, a relatively thin metal plate.

The money handling apparatus 1 is installed with the lower side surface of the upper housing 111 and the upper side surface of the lower housing 112 in contact with each other.

The upper housing 111 comprises a door 113 allowing access to the interior the upper housing. The lower housing 112 comprises a door 114 allowing access to the interior the lower housing. In the example illustrated FIG. 1, the door 113 is provided on the upper side surface of the upper housing 111, and the door 114 is provided on the front side surface of the lower housing 112. However, in the present disclosure, the door may be provided on other surfaces of the housing, such as the rear side surface or the side surface of the housing, as described below.

The door 113 and the door 114 are respectively attached to the upper housing 111 and the lower housing 112 with, for example, hinges in such a way that the doors can be opened and closed.

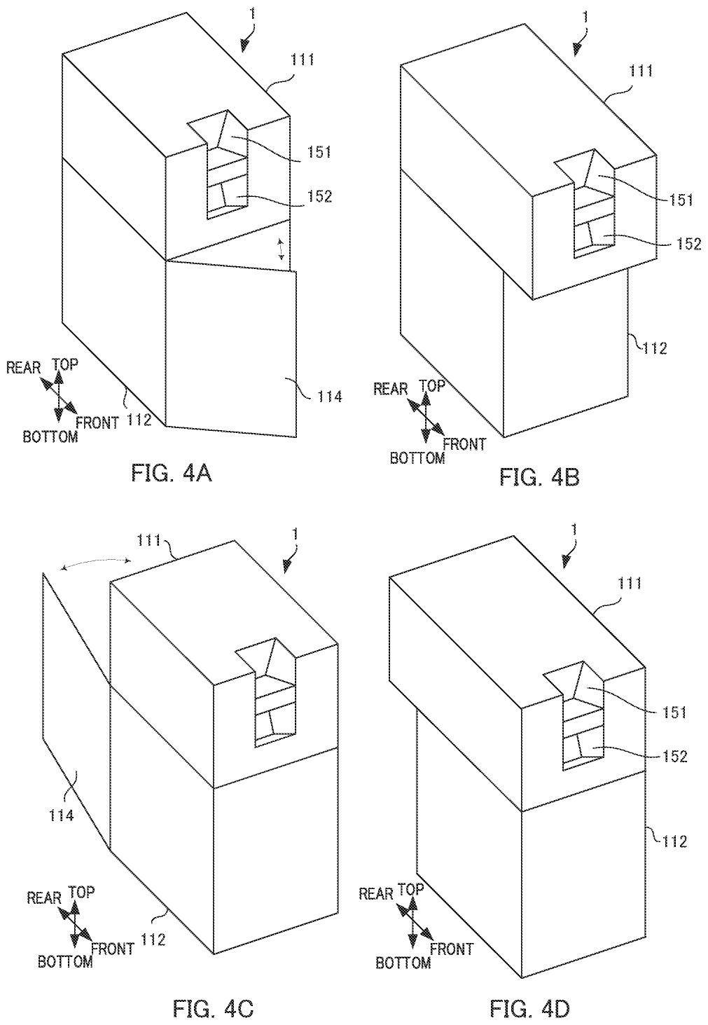

The upper module 12 comprises a deposit unit 121 for accepting money deposited from an inlet 151 (see FIGS. 4A to 4D below) provided in the housing 11, a withdrawal unit 122 for dispensing money to an outlet 152 (see FIGS. 4A to 4D below) provided in the housing 11, and an upper transport section 123 for transporting money within the upper module 12. The upper module 12 may further comprise, for example, a temporary holding section that temporarily holds deposited money within the upper module 12.

The upper transport section 123 transports money between the deposit unit 121, the withdrawal unit 122, and a connection end 124 provided at the lower end of the upper module 12. The connection end 124 is one end of the upper transport section 123 and can be connected with the connection end 133 (details thereof will be described below) of the lower transport section 132. The other ends of the upper transport section 123 are provided in the deposit unit 121 and the withdrawal unit 122.

The connection end 124 has, for example, a comb-shaped structure. The connection end 124 is configured in such a way that money can be transferred between the connection end 124 and the connection end 133 of the lower transport section 132, which has a similar structure, by meshing the comb-shaped structures with each other. Herein, the connection between the connection ends means that the positions of the connection ends of the two transport sections are aligned and the comb-shaped structures are meshed with each other. The connection between the connection ends can be easily released, for example, by moving one of the modules.

The upper transport section 123 can feed money downward or take money upward from the connection end 124.

The lower surface of the upper housing 111 and the upper surface of the lower housing 112 are respectively provided with openings for transferring money between the upper transport section 123 and the lower transport section 132.

Each component of the upper module 12 is attached to an upper frame 125, for example. The upper frame 125 is composed of a combination of rods or thin plates each disposed along the vertical direction or the horizontal direction. The upper frame 125 is provided with holes for attaching components of the upper module 12 thereto by using screws or the like.

Rather than being attached to the upper frame 125, components of the upper module 12 may be connected to each other.

The lower module 13 comprises a storage section 131 for storing money and a lower transport section 132 for transporting money within the lower module 13. The lower module 13 may further comprise a control unit for controlling the operation of the entire money handling apparatus 1.

The storage section 131 stores and holds money. The storage section 131 may be a collecting section that does not have a mechanism for discharging stored money, or a recycling section that has a mechanism for discharging stored money. The money handling apparatus 1 can discharge for the reuse of the money stored in the recycling section, but cannot discharge the money stored in the collecting section.

The lower module 13 may comprise a plurality of storage sections 131 as illustrated in FIG. 1. In this case, the plurality of storage sections 131 may comprise both types of sections, namely the collecting section and the recycling section, or may comprise only one type of section.

The lower transport section 132 transports money between the storage section 131 (each of the plurality of storage sections 131 when there are a plurality of storage sections 131) and the connection end 133 provided at the upper end of the lower module 13. The connection end 133 is one end of the lower transport section 132 and can be connected with the connection end 124 of the upper module 12. The connection end 133 has a comb-shaped structure similar to that of the connection end 124 described above. The connection end 133 is configured in such a way that money can be transferred by meshing the comb-shaped structures with each other.

The lower transport section 132 can feed money upward or take money downward from the connection end 133.

Each component of the lower module 13 is attached to a lower frame 134, for example. The lower frame 134 is composed of a combination of rods or thin plates each disposed along the vertical direction or the horizontal direction. The lower frame 134 is provided with holes for attaching components of the lower module 13 thereto by using screws or the like.

The lower frame 134 is held inside the lower housing 112 by a movement mechanism 135 such as a rail. As a result, the lower frame 134 and each component attached to the lower frame 134 (including the middle transport module 14 as described below) can be pulled out along the movement mechanism 135 to the outside of the housing 11 with the door 114 open. In the example illustrated FIG. 1, the movement mechanism 135 is disposed at the bottom of the lower housing 112; however, for example, the movement mechanism may be disposed at the top of the lower housing, and each component attached to the lower frame 134 may be suspended from and held by the movement mechanism.

As described above, in the money handling apparatus 1, the upper transport section 123 of the upper module 12 and the lower transport section 132 of the lower module 13 are connected to each other through the connection ends thereof, and money can be transported between the upper module 12 and the lower module 13.

In the present disclosure, the money handling apparatus 1 having such a configuration can be reconfigured as a whole by further adding a middle transport module 14 described below. The middle transport module 14 is a module configured to transport money between the upper module 12 and the lower module 13. In the present disclosure, it is assumed that middle transport modules 14 having a plurality of shapes (i.e., plurality of middle transport modules 14 having different shapes) are designed and produced in advance as described in detail below.

The money handling apparatus 1 may be designed in various external shapes, as will be described below with reference to FIGS. 4A to 4D. Change in the external shape of the money handling apparatus 1 changes the shape of the housing 11. Along with this change, the layout of the upper module 12 and the lower module 13 inside the housing 11 is also changed.

For this reason, the middle transport module 14 having a form that matches the layout corresponding to a desired external shape is selectively attached to the money handling apparatus 1. As a result, the middle transport module 14 can absorb the positional deviation between the connection ends caused by changing the layout of the upper module 12 and the lower module 13. Therefore, the layout of the upper module 12 and the lower module 13 can be changed relatively easily without changing the configuration of each of the upper module 12 and the lower module 13. In the following, the middle transport module 14 will be described in detail.

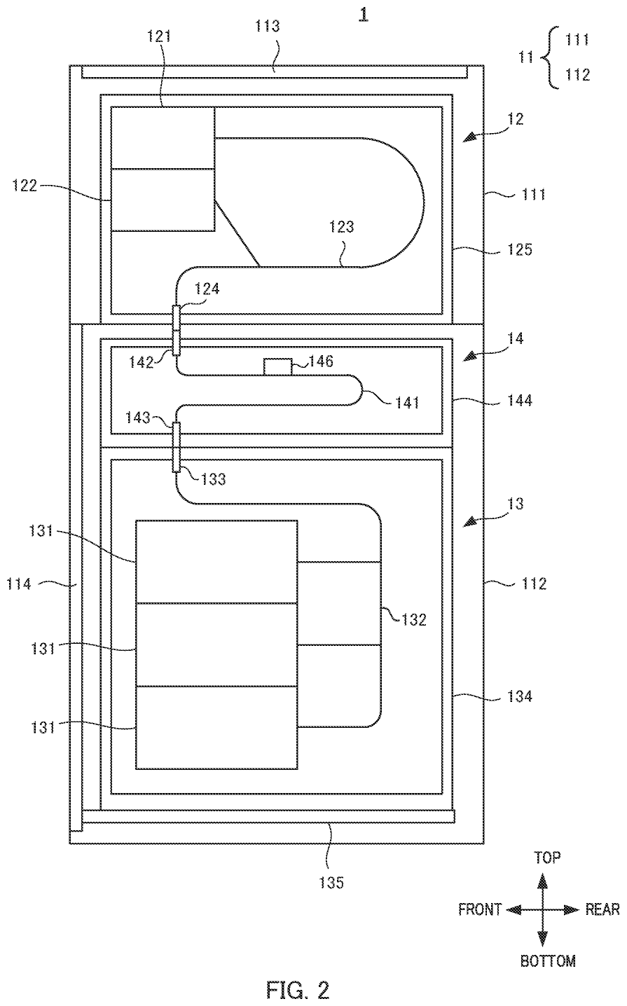

FIG. 2 illustrates money handling apparatus 1 illustrated in illustrated FIG. 1 with the middle transport module 14 being added thereto. As illustrated in FIG. 2, the middle transport module 14 is attached to the upper portion of the lower module 13 and together with the lower module 13 housed inside the lower housing 112. In FIG. 2, the lower housing 112 is configured to have a shape larger than that illustrated in FIG. 1 due to the addition of the middle transport module 14.

The middle transport module 14 comprises a middle transport section 141, an upper side connection end 142, and a lower side connection end 143. The upper side connection end 142 is connected with the connection end 124, which is one end of the upper transport section 123. The lower side connection end 143 is connected with the connection end 133, which is one end of the lower transport section 132. The configuration allows the middle transport section 141 to transfer money to/from upper transport section 123 and the lower transport section 132. The upper side connection end 142 is an exemplary first end of the present disclosure, and the lower side connection end 143 is an exemplary second end of the present disclosure.

The middle transport section 141 can feed money upward or take money downward from the upper side connection end 142. The middle transport section 141 can feed money downward or take money upward from the lower side connection end 143.

The middle transport section 141 of the middle transport module 14 is attached to a middle frame 144. The middle frame 144 is composed of a combination of rods or thin plates each disposed along the vertical direction or the horizontal direction. The middle frame 144 is provided with a hole for attaching the middle transport section 141 thereto by using a screw or the like.

The middle transport module 14 is attached to the lower module 13 by attaching the middle frame 144 to the lower frame 134 from above. The middle frame 144 is attached to the lower frame 134 by using a screw or the like. The middle frame 144 and the lower frame 134 are provided with marks for positioning to each other, and are configured to be easily attached when the money handling apparatus 1 is produced. Examples of the mark include projections and holes (each capable of accommodating the corresponding projection) provided on/in the middle frame 144 and the lower frame 134. In addition, the middle transport module 14 can be removed from the lower module 13.

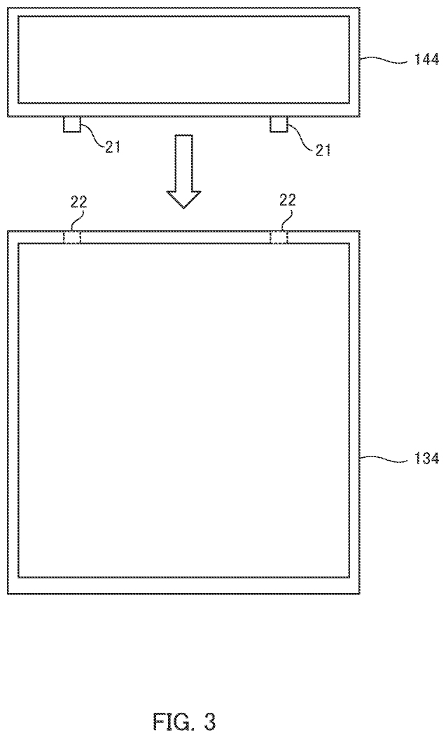

The middle frame 144 is attached to the lower frame 134 from above. FIG. 3 illustrates how the middle frame 144 is attached to the lower frame 134. As illustrated in FIG. 3, the middle frame 144 is fixed to the lower frame 134 by being attached to the upper side of the lower frame 134 with a screw or the like. As illustrated in FIG. 3, the middle frame 144 is provided with protrusions 21 for positioning. The middle frame 144 is positioned with respect to the lower frame 134 by fitting the protrusions 21 into slits 22 provided in the lower frame 134.

Each component of the lower module 13 is attached to the lower frame 134 so as not to protrude upward from the upper end of the lower frame 134. Therefore, the middle frame 144 can be easily disposed on the upper side of the lower frame 134, and the middle frame 144 can be easily attached to the upper side of the lower frame 134 with a screw or the like.

The middle frame 144, to which the middle transport module 14 is fixed, is attached to the lower frame 134 in this manner; thus, when the components of the lower module 13 is pulled out of the housing 11 by the movement mechanism 135, the middle transport module 14 is also pulled out of the housing 11 at the same time.

As described above, in the present disclosure, middle transport modules 14 having a plurality of shapes are prepared in advance, and an appropriate middle transport module 14 is selected according to the layout of the upper module 12 and the lower module 13. Specifically, regarding the middle transport modules 14 having a plurality of shapes, the positions of the upper side connection ends 142 are different to each other, and the positions of the lower side connection ends 143 are also different to each other. Accordingly, the shapes of the transport paths are also different to each other. Details of the middle transport modules 14 having a plurality of shapes will be described below.

An exemplary overall configuration of the money handling apparatus 1 has been described above. The money handling apparatus 1 comprises an upper module 12 for handling deposits and withdrawals of money, and a lower module 13 comprising a storage section 131 for storing money. Among the middle transport modules 14 having a plurality of shapes, a middle transport module 14 having a shape that matches the desired layout of the upper module 12 and the lower module 13 is attached to the lower module 13 from above.

In the following, various external shapes of the money handling apparatus 1 will be described with specific examples. FIGS. 4A to 4D are diagrams for explaining specific examples of the external shape of the money handling apparatus 1.

FIG. 4A illustrates a first example of the external shape of the money handling apparatus 1. The money handling apparatus 1 illustrated in FIG. 4A comprises an inlet 151 and an outlet 152. The inlet 151 and the outlet 152 are provided on the front side of the upper housing 111 of the money handling apparatus 1.

In the example illustrated in FIG. 4A, a door 114 is provided on the surface of the lower housing 112 on the front side.

The money handling apparatus 1 illustrated in FIG. 4A is installed, for example, against a wall. In this case, a user who deposits or withdraws money to or from the money handling apparatus 1 uses the money handling apparatus 1 from the front side of the housing 11 through the inlet 151 or the outlet 152. An administrator who replenishes the storage section 131 (see FIG. 1) of the money handling apparatus 1 with money or collects money from the storage unit 131 have access to the inside of the lower housing 112 from the front side of the lower housing 112 through the door 114. FIG. 4A illustrates the door 114 being slightly opened.

FIG. 4B illustrates a second example of the external shape of the money handling apparatus 1. The money handling apparatus 1 illustrated in FIG. 4B has a shape such that a portion of the housing 11 in the vicinity of the inlet 151 and the outlet 152 protrudes toward the front side as compared to the first example illustrated in FIG. 4A.

Such an external shape can bring inlet 151 and outlet 152 closer to a place where users can enter even when, for example, there is some distance between the installation place of the money handling apparatus 1 and the place where users can enter. Therefore, a user can easily reach the inlet 151 and outlet 152.

FIG. 4C illustrates a third example of the external shape of the money handling apparatus 1. In the money handling apparatus 1 illustrated in FIG. 4C, the door 114 of the lower housing 112 is provided not on the front side of the housing 11 but on the rear side thereof. Otherwise, the external shape of this example is almost the same as the external shape illustrated in FIG. 4A.

Money handling apparatus 1 illustrated in FIG. 4C is installed, for example, in an opening of a wall obtained by hollowing the wall out along a cross-sectional shape of the money handling apparatus 1 perpendicular to the front-rear direction of the money handling apparatus 1. With such an arrangement, the inlet 151 and the outlet 152 to be used by users can be disposed within a space where users can enter, and the door 114 for an administrator to reach the storage section 131 is disposed in a space where users cannot enter because of the presence of the wall. In this case, the administrator can replenish the storage section 131 with money or collect money from the storage section 131 in the space where users cannot enter, thereby achieving relatively high security.

FIG. 4D illustrates a fourth example of the external shape of the money handling apparatus 1. The money handling apparatus 1 illustrated in FIG. 4D has a shape such that a portion of the housing 11 in the vicinity of the inlet 151 and the outlet 152 protrudes toward the rear side as compared to the first example illustrated in FIG. 4A.

Therefore, the external shape of the money handling apparatus 1 may take various shapes according to the required positions of the inlet 151 and the outlet 152, or the position of the door 114 for allowing access to the storage section 131.

In order to obtain such money handling apparatuses 1 having various external shapes, it is necessary to change the internal structure of the money handling apparatus 1 according to the external shape. By changing the layout itself of each configuration in the upper module 12 and the lower module 13 (see FIG. 1), it is possible to easily adapt to any external shape. However, in this case, design changes of the upper module 12 and the lower module 13 are required, which increases the design cost of the upper module 12 and the lower module 13 and thus the production cost of the money handling apparatus 1.

The present disclosure performs the following: the upper module 12 and the lower module 13 are modularized to share respective common structures corresponding to any external shape; the middle transport modules 14 having a plurality of shapes are prepared in advance; the shape of the middle transport module 14 that connects the upper module 12 with the lower module 13 is selected according to the required external shape. This eliminates the need for new design costs for the upper module 12 and the lower module 13, making it possible to obtain money handling apparatuses 1 having various external shapes at low cost.

Details of Middle Transport Module 14

Example of Shape of Middle Transport Module 14

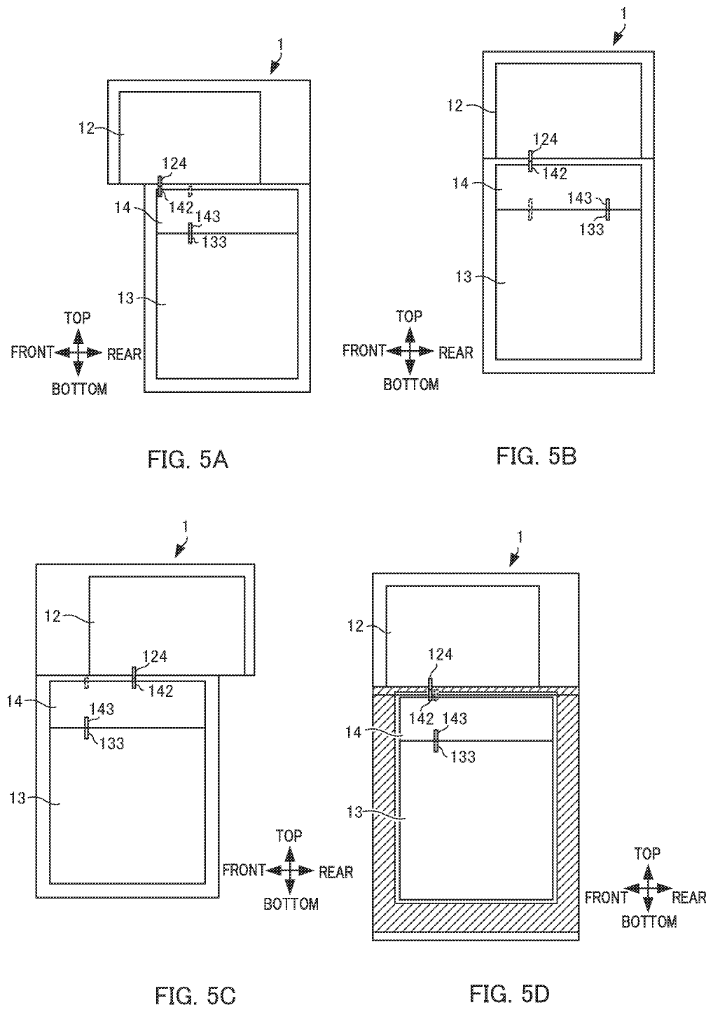

In the following, the shapes of the middle transport modules 14 for obtaining money handling apparatuses 1 having various external shapes. FIGS. 2 and 5A to 5D illustrate internal structures of money handling apparatuses 1 for obtaining money handling apparatuses 1 having various external shapes as illustrated in FIG. 4.

FIG. 2 illustrates an internal structure for achieving the external shape of the money handling apparatus 1 illustrated in FIG. 4A. FIG. 5A illustrates an internal structure for achieving the external shape of the money handling apparatus 1 illustrated in FIG. 4B. FIG. 5B illustrates an internal structure for achieving the external shape of the money handling apparatus 1 illustrated in FIG. 4C. FIG. 5C illustrates an internal structure for achieving the external shape of the money handling apparatus 1 illustrated in FIG. 4D. FIG. 5D illustrates an exemplary internal structure when the lower housing 112 is designed as a safe. In FIGS. 5A to 5D, when the position of a connection end in any one of FIGS. 5A to 5D is different from that of the internal structure illustrated in FIG. 2, the position of the connection end in FIG. 2 is indicated by a dashed line.

In the internal structures of the money handling apparatuses 1 illustrated in FIGS. 1, 2 and 5A to 5D, the upper modules 12 share a common shape, and also the lower modules 13 share a common shape. That is, in the examples illustrated in FIGS. 1, 2, and 5A to 5D, a common upper module 12 and a common lower module 13 are used, and the shape of the middle transport module 14 is changed, thereby obtaining money handling apparatuses 1 having various external shapes.

In the example illustrated FIG. 5A, the upper module 12 is disposed in a state of being shifted toward the front side with respect to the lower module 13 as compared to the internal structure illustrated in FIG. 2. The position where the lower module 13 is disposed is the same as in the internal structure illustrated in FIG. 2. In this case, the position of the connection end 124 of the upper module 12 is on the front side as compared to the internal structure illustrated in FIG. 2. On the other hand, the position of the connection end 133 of the lower module 13 remains unchanged. Therefore, regarding the positional relationship between the upper side connection end 142 of the middle transport module 14—the upper side connection end to be connected to the connection end 124—and the lower side connection end 143 of the middle transport module 14—the lower side connection end to be connected to the connection end 133, the positional relationship differs between the internal structure illustrated in FIG. 2 and the internal structure illustrated in FIG. 5A.

Therefore, for the example illustrated in FIG. 5A, a middle transport module 14, whose upper side connection end 142 is positioned closer to the front side than that in the example illustrated in FIG. 2 is, is selected and used.

In the example illustrated in FIG. 5B, the lower module 13 is installed with its front and rear reversed from the example illustrated in FIG. 2. This configuration allows access to the storage section 131 of the lower module 13 for the administrator from the rear side of the money handling apparatus 1 through the door 114 installed on the rear side, as illustrated in FIG. 4C.

In the example illustrated in FIG. 5B, the position of the connection end 133 of the lower module 13 is reversed in the front-rear direction from the example illustrated in FIG. 2. Therefore, for the example illustrated in FIG. 5B, a middle transport module 14, whose lower side connection end 143 is positioned closer to the rear side than that in the example illustrated in FIG. 2 is, is selected and used.

In the example illustrated FIG. 5C, the upper module 12 is disposed in a state of being shifted toward the rear side with respect to the lower module 13 as compared to the internal structure illustrated in FIG. 2. In this case, the position of the connection end 124 of the upper module 12 is on the rear side as compared to the internal structure illustrated in FIG. 2. Therefore, for the example illustrated in FIG. 5C, a middle transport module 14, whose upper side connection end 142 is positioned closer to the rear side than that in the example illustrated in FIG. 2 is, is selected and used.

In the example illustrated FIG. 5D, the upper module 12 is housed in an upper housing 111 which is a metal case, while the lower module 13 is housed in a lower housing 112 designed as a safe. Compared to the housing (metal case) not designed as a safe as illustrated in FIG. 1, a case designed as a safe is a housing that can prevent intrusion from the outside by firmly joining various parts of a thick metal plate by welding or the like.

As illustrated FIG. 5D, when the lower module 13 and the middle transport module 14 are housed in the lower housing 112 designed as a safe, the middle transport module 14 with the upper side connection end 142 positioned close to the front side is selected and used. In FIG. 5D, the inner wall portion of the lower housing 112 designed as a safe is hatched.

When the lower housing 112 is designed as a safe and the upper housing 111 is not designed as a safe, the following configuration is required as illustrated in FIG. 5D in order to bring the front surface of the upper housing 111 flush with the front surface of the lower housing 112: the position of the upper module 12 housed in the upper housing 111 is positioned relatively closer to the front side than the positions of the lower module 13 and the middle transport module 14 are. Therefore, the middle transport module 14 with the upper side connection end 142 positioned close to the front side is selected and used as described above. When the comb-shaped structure of the connection end 124 cannot mesh with the comb-shaped structure of the upper side connection end 142 due to the thickness of the safe, an additional transport path having a thickness corresponding to the thickness of the safe and comprising comb-shaped structures on the top and bottom of the additional transport path may be added.

Example of Configuration of Middle Transport Module 14

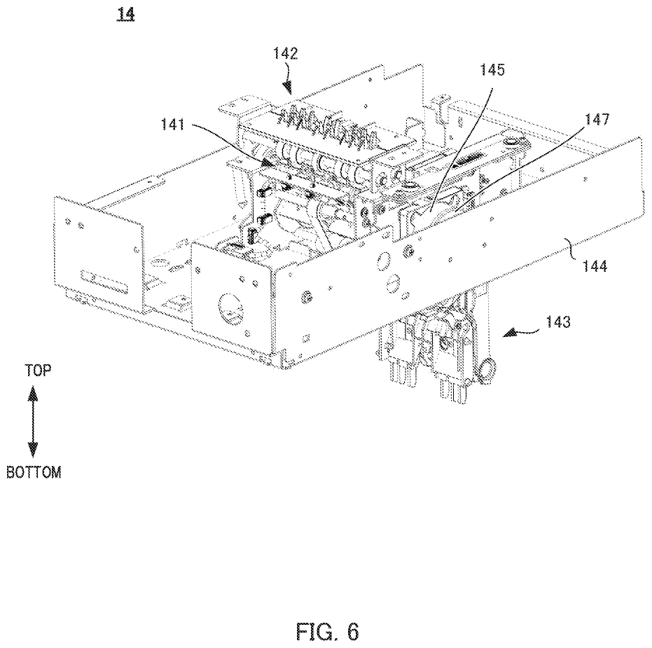

In the following, the structure of the middle transport module 14 will be described with reference to FIGS. 2 and 6. FIG. 6 is a perspective view illustrating an exemplary middle transport module 14. The vertical direction in FIG. 6 corresponds to the vertical direction of the middle transport module 14 attached to the money handling apparatus 1.

As illustrated in FIGS. 2 and 6, the upper surface of the middle transport module 14 is provided with the upper side connection end 142. In addition, the lower surface of the middle transport module 14 is provided with the lower side connection end 143. Between the upper side connection end 142 and the lower side connection end 143, a middle transport section 141 composed of a belt, rollers, and the like is disposed. The upper side connection end 142 has an upward comb-shaped structure, and the lower side connection end 143 has a downward comb-shaped structure.

The middle transport module 14 also comprises a motor 145 for driving the middle transport section 141. When the middle transport module 14 is attached to the lower module 13, the control of the motor 145 may be performed by a control unit configured to control the entire operation of the money handling apparatus 1.

As the middle transport module 14 comprises the motor 145 for operating the middle transport section 141 in this manner, the middle transport section 141 can be operated independently of the upper transport section 123 and the lower transport section 132.

In addition, the middle transport section 141 is provided with a detection section 146 for detecting money being transported. The detection unit 146 is, for example, an optical sensor, and detects the blocking of light by money.

In addition, the middle transport section 141 is provided with a manual movement mechanism 147 for manually moving money in the middle transport section 141 by an administrator or the like while the motor 145 is stopped during the transportation. The manual movement mechanism 147 is referred to as, for example, a manual knob, and is manually rotated to rotate the rollers of the middle transport section 141 and move the belt, thereby moving money in the middle transport section 141 while the motor 145 is stopped during the transportation.

Method for Producing Money Handling Apparatus 1

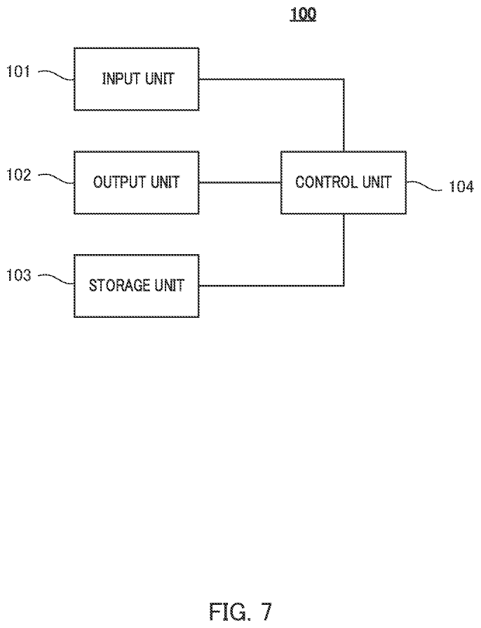

In the following, a method for producing the money handling apparatus 1 described above, the method including designing of the money handling apparatus, will be described. FIG. 7 is a diagram illustrating an exemplary configuration of a production control apparatus 100 configured to control production of the money handling apparatus 1.

As illustrated in FIG. 7, the production control apparatus 100 comprises an input unit 101, an output unit 102, a storage unit 103 and a control unit 104.

The input unit 101 is composed of a mouse, a keyboard, a touch pad, various keys, and buttons, and the like.

The output unit 102 outputs control information generated by the production control apparatus 100. The output unit 102 may be composed of a liquid crystal display, an organic electro luminescence (EL) display, or the like, or may be composed of an interface or the like for outputting control information to a production apparatus that performs the production of the money handling apparatus 1.

The storage unit 103 is composed of a hard disk drive (HDD), a solid state drive (SSD), or the like. The storage unit 103 stores in advance information necessary for generating control information, such as information on the shapes of the middle transport modules 14 in the production. Further, the storage unit 103 stores, for example, programs to be executed by the control unit 104.

The control unit 104 is composed of, for example, a processor such as a central processing system (CPU). The control unit 104 reads out a program used for producing money handling apparatus 1 from storage unit 103 and executes the program, thereby generating control information for controlling the production of the money handling apparatus 1 based on input information and information stored in storage unit 103.

As described above, production control apparatus 100 is a computer comprising an input unit, a storage unit, and a processor.

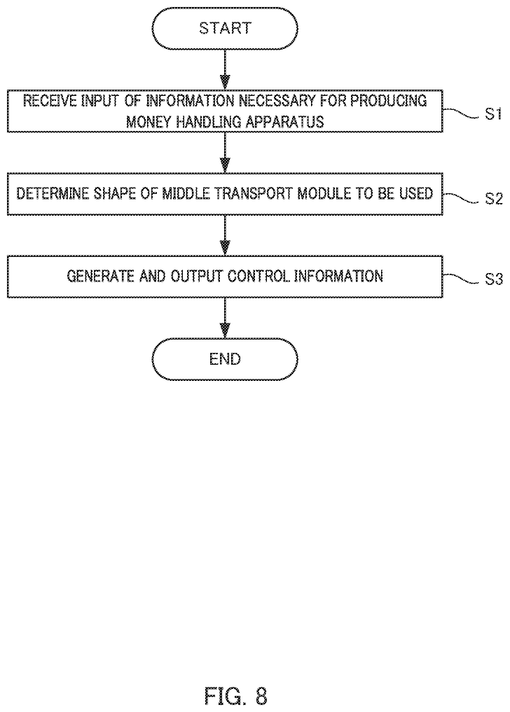

FIG. 8 is a flow chart for explaining a method for producing the money handling apparatus 1 by the production control apparatus 100.

As illustrated in FIG. 8, the production control apparatus 100 receives an input operation of information necessary for designing and producing the money handling apparatus 1 in step S1. The information necessary for designing and producing the money handling apparatus 1 includes the following: information indicating the shapes of the upper module 12 and the lower module 13; information indicating the positions of the connection end 124 of the upper module 12 and the connection end 133 of the lower module 13; information indicating the orientations of the upper module 12 and the lower module 13; and the like. The input operation in step S1 is performed, for example, by a manufacturer involved in the production of the money handling apparatus 1.

In step S2, the production control apparatus 100 determines the shape of the middle transport module 14 to be used. This determination may be performed based on, for example, the information on the shape of the middle transport module 14 stored in the storage unit 103, more specifically, on the information indicating the positions of the upper side connection end 142 and the lower side connection end 143 and the information input in step S1.

In step S3, the production control apparatus 100 generates and outputs control information including the determined shape of the middle transport module 14. The control information may include the following: information indicating the determined shape of the middle transport module 14; information indicating information for recognizing the determined middle transport module 14 (such as an recognition number given in advance); information indicating the positions of connection end 124 of the upper module 12 and the connection end 133 of the lower module 13; and the like.

The production control apparatus 100 displays control information on a display serving as the output unit 102, for example. As a result, the manufacturer of the money handling apparatus 1 can easily determine which shape of the middle transport module 14 should be used to produce the desired money handling apparatus 1.

Alternatively, the production control apparatus 100 outputs the control information via an interface serving as the output unit 102 to a manufacturing robot that produces the money handling apparatus 1, for example. As a result, the manufacturing robot can produce the desired money handling apparatus 1 by using the middle transport module 14 having the shape included in the control information.

The production control apparatus 100 may cancel the use of the middle transport module 14 when the information input in step S1 indicates that the position of the connection end 124 of the upper module 12 matches the position of the connection end 133 of the lower module 13. In this case, the production control apparatus 100 generates control information causing the upper module 12 and the lower module 13 to be aligned without using the middle transport module 14 and then the connection end 124 and the connection end 133 to be connected with each other.

As descried above, a money handling apparatus 1 according to an embodiment of the present disclosure comprises an upper module 12 comprising an upper transport section 123 for transporting money, and a lower module 13 comprising a lower transport section 132 for transporting money. In the embodiment, a middle transport section 141 is configured to transport money between an upper side connection end 142 (a first end in the present disclosure) to be connected to a connection end 124, namely the end of the upper transport section 123, and a lower side connection end 143 (the second end of the present disclosure) to be connected to the connection end 133, namely the end of the lower transport section 132. Among a plurality of middle transport modules 14 each comprising the middle transport section 141 configured as above, a middle transport module 14 having a configuration such that the positions of the connection end 124 of the upper transfer part 123 and the upper side connection end 142 match each other, and the positions of the connection end 133 of the lower transfer part 132 and the lower side connection end 143 match each other is attached to the lower module 13.

With such a configuration, the money handling apparatus 1 according to the present disclosure can be easily produced without changing the layout inside the upper module 12 and the lower module 13 even when the upper module 12 and lower module 13 are arranged in different layouts by selecting a middle transport module 14 whose position matches the positions of the upper module 12 and the lower module 13 in each layout from among a plurality of middle transport modules 14 prepared in advance. Therefore, various money handling apparatuses 1 in which the upper module 12 and the lower module 13 are arranged in various layouts can be easily produced at low cost.

In addition, the middle transport module 14 is attached and fixed to the lower frame 134 of the lower module 13 from above. As a result, the middle transport module 14 may be attached to the lower frame 134 by placing the middle transport module 14 from above the lower frame 134 and fixing the middle transport module with a screw or the like. Such a middle transport module can be easily attached as compared with the case of another structure where a middle transport module is attached from below.

In addition, in the money handling apparatus 1, the middle transport module 14 is housed in the lower housing 112 together with the lower module 13. Therefore, the money handling apparatus 1 can be provided without increasing the size of the upper housing 111. It should be noted that the lower housing 112 needs to house the middle transport module 14;

thus, it is necessary to increase the size of the lower housing 112 as compared with the case where there is no middle transport module. However, by allocating a space (of the space inside the lower housing 112 having increased due to the increased size of the lower housing 112) other than the space required for installing the middle transport module 14 to the storage space for the storage section 131, the storage capacity of the storage section 131 can be increased.

Variation

The above embodiment describes a money handling apparatus 1 separately housing an upper module 12 in an upper housing 111 and a lower module 13 and a middle transport module 14 in a lower housing 112. However, the present disclosure is not limited thereto, and both the upper module and the lower module may be fixed to one cradle, and the upper module and the lower module may be housed together with the cradle in one housing. For adding a middle transport module, the middle transport module may also be fixed to the cradle.

In this case, the cradle may have a mechanism for moving the upper and lower modules (and the middle transport module) toward the front side, for example. As a result, for example, when a door is provided on the front surface side of the housing 11, all the upper module and lower module (and the middle transport module) can be pulled out from this door.

What is claimed is:

1. A money handling apparatus, comprising:
an upper module comprising an upper transport section for transporting money; and
a lower module comprising a lower transport section for transporting the money,
wherein
a middle transport module comprising a middle transport section for transporting the money between a first end to be connected to an end of the upper transport section and a second end to be connected to an end of the lower transport section is selectively attached to the lower module to place the end of the upper transport section and the end of the lower transport section in one of a plurality of different positional relationships between the ends of the upper and lower transport sections to enable transporting of the money between the upper transport section and the lower transport section.

2. The money handling apparatus according to claim 1, wherein:
the lower module further comprises a lower frame to which the lower transport section is attached; and
the middle transport module is attached and fixed to the lower frame.

3. The money handling apparatus according to claim 2, wherein
the lower module further comprises a movement mechanism for moving the lower frame with the lower transport section and the middle transport module attached thereto.

4. The money handling apparatus according to claim 2, further comprising:
a lower housing for housing the lower frame inside, the lower frame being with the lower transport section and the middle transport module attached thereto.

5. The money handling apparatus according to claim 2, wherein
the middle transport module is attached to the lower frame from above.

6. The money handling apparatus according to claim 2, wherein:
the middle transport module comprises a middle frame to which the middle transport section is attached; and
the middle transport module is fixed to the lower module by attaching the middle frame to the lower frame.

7. The money handling apparatus according to claim 1, wherein
the middle transport module further comprises a motor for operating the middle transport section.

8. The money handling apparatus according to claim 1, wherein
the middle transport module further comprises a detection section for detecting the money transported by the middle transport section.

9. The money handling apparatus according to claim 1, wherein
the middle transport module further comprises a manual movement mechanism for manually moving the money in the middle transport section.

10. The money handling apparatus according to claim 6, wherein
the middle frame comprises a protrusion, and is positioned by engaging the protrusion with a slit of the lower frame.

11. The money handling apparatus according to claim 1, wherein
among a plurality of the middle transport modules having different positional relationships between the first end and the second end, a middle transport module having a configuration such that positions of the end of the upper transport section and the first end match each other and positions of the end of the lower transport section and the second end match each other is selectively attached to place the end of the upper transport section and the end of the lower transport section in one of the plurality of different positional relationships between the ends to enable the transporting of the money between the upper transport section and the lower transport section.

12. The money handling apparatus according to claim 3, wherein
the middle transport module is exposed when the lower frame is pulled out by the movement mechanism.

13. The money handling apparatus according to claim 4, wherein:
when the lower housing is not a safe, the middle transport module is not attached, and a front surface of the upper module and a front surface of the lower module are aligned with each other; and
when the lower housing is a safe, the middle transport module is attached, and the front surface of the upper module and a front surface of the safe housing the lower module are aligned with each other.

14. A method for producing a money handling apparatus that comprises an upper module comprising an upper transport section for transporting money and a lower module comprising a lower transport section for transporting the money, the method comprising:
acquiring, by a computer, information about a position of an end of the upper transport section and a position of an end of the lower transport section;
selecting, by the computer, among a plurality of middle transport modules respectively comprising middle transport sections that have different positional relationships between a first end and a second end of each middle transport section, a middle transport module having a configuration such that the position of the end of the upper transport section and a position of the first end match each other, and the position of the end of the lower transport section and a position of the second end match each other; and
outputting, by the computer, information about the middle transport module selected.

15. A program for producing a money handling apparatus that comprises an upper module comprising an upper transport section for transporting money and a lower module comprising a lower transport section for transporting the money, the program causing a computer to execute procedures comprising:
acquiring information about a position of an end of the upper transport section and a position of an end of the lower transport section;
selecting, among a plurality of middle transport modules respectively comprising middle transport sections that have different positional relationships between a first end and a second end of each middle transport section, a middle transport module having a configuration such that the position of the end of the upper transport section and a position of the first end match each other, and the position of the end of the lower transport section and a position of the second end match each other; and
outputting information about the middle transport module selected.
